(19) United States
(12) Patent Application Publication
(10) Pub. No.: US 2026/0003574 A1
(43) Pub. Date: Jan. 1, 2026

(54) MEMORY DEVICE AND OPERATING METHOD THEREOF

(71) Applicants: TAIWAN SEMICONDUCTOR MANUFACTURING COMPANY, LTD., Hsinchu (TW); NATIONAL TSING HUA UNIVERSITY, Hsinchu City (TW)

(72) Inventors: Yi-Lun LU, New Taipei City (TW); Tai-Hao WEN, New Taipei City (TW); Yu-Chen CHANG, Kaohsiung City (TW); Win-San KHWA, Taipei City (TW); Jui-Jen WU, Hsinchu (TW); Meng-Fan CHANG, Taichung City (TW)

(73) Assignees: TAIWAN SEMICONDUCTOR MANUFACTURING COMPANY, LTD., Hsinchu (TW); NATIONAL TSING HUA UNIVERSITY, Hsinchu City (TW)

(21) Appl. No.: 18/759,581

(22) Filed: Jun. 28, 2024

(51) Int. Cl. G06F 7/523; G06F 7/50

(52) U.S. Cl. CPC G06F 7/523; G06F 7/50

(57) ABSTRACT

A memory device includes a memory array configured to store weight data; a control logic configured to transmit input data to activate different numbers of multiple word lines in each of multiple cycles of multiply-and-accumulate (MAC) operations on the weight data and the input data; and multiple read circuits coupled to the memory array through multiple bit lines, and configured to generate, in response to a control signal, multiple read voltages based on multiple reference voltages in the cycles of MAC operations to the bit lines. The reference voltages are different from each other.

### BACKGROUND

The advancement of modern semiconductor manufacturing processes and the ever-increasing numbers of data generated each day have created a pressing need to store and process large numbers of data. This has led to a motivation to find improved ways of storing and processing large numbers of data. While it is possible to process large quantities of data in software using conventional computer hardware, existing computer hardware can be inefficient for some data-processing applications. For instance, machine learning has emerged as an effective way to analyze and derive value from large data sets in countless fields. However, machine learning performed on conventional computer systems can involve excessive data transfers between memory and the processor, leading to high power consumption and slow compute times.

Compute-in-memory (CIM) (which can also be referred to as in-memory processing) has been utilized for machine learning and involves performing compute operations within a memory array. Consequently, compute operations are conducted directly on the data read from the memory cells, rather than transferring the data to a digital processor for processing. By avoiding transferring some data to the digital processor, the bandwidth limitations associated with transferring data back and forth between the processor and memory in a conventional computer system are reduced. In some applications, energy consumption of CIM operations is a significant concern.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a memory device in accordance with some embodiments of the present disclosure.

FIG. 2 is a schematic diagram of a read circuit in the memory device shown in FIG. 1, in accordance with some embodiments of the present disclosure.

FIG. 3A is a schematic diagram of input data, in accordance with some embodiments of the present disclosure.

FIG. 3B is schematic diagram of weight data, in accordance with some embodiments of the present disclosure.

FIG. 4 is a flowchart of a method of operating a memory device, in accordance with some embodiments of the present disclosure.

FIG. 5 is schematic diagram of input data, weight data, and accumulation number, in accordance with some embodiments of the present disclosure.

FIGS. 6A-6B schematic diagrams of the memory device performing multiply-accumulate (MAC) operations on the first portion of the input data and the first portion of the weight data, in accordance with some embodiments of the present disclosure.

FIGS. 6C-6D schematic diagrams of the memory device performing MAC operations on the first portion of the input data and the second portion of the weight data, in accordance with some embodiments of the present disclosure.

FIGS. 6E-6F schematic diagrams of the memory device performing MAC operations on the second portion of the input data and the first and second portions of the weight data, in accordance with some embodiments of the present disclosure.

FIGS. 6G-6H schematic diagrams of the memory device performing MAC operations on the third portion of the input data and the first and second portions of the weight data, in accordance with some embodiments of the present disclosure.

FIGS. 7A-7B schematic diagrams of the memory device performing MAC operations on the first portion of the input data and the first and second portions of the weight data, in accordance with some embodiments of the present disclosure.

FIGS. 7C-7D schematic diagrams of the memory device performing MAC operations on the second portion of the input data and the first and second portions of the weight data, in accordance with some embodiments of the present disclosure.

FIGS. 7E-7F schematic diagrams of the memory device performing MAC operations on the second portion of the input data and the first and second portions of the weight data, in accordance with some embodiments of the present disclosure.

FIG. 8A is a schematic diagram of a memory device, in accordance with some embodiments.

FIG. 8B is a schematic diagram of a neural network, in accordance with some embodiments.

FIG. 8C is a schematic diagram of an integrated circuit (IC) device, in accordance with some embodiments.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

This application relates to computing-in-memory (CIM) using neural networks. The neural networks, consisting of interconnected processing nodes, analyze data by computing weights and rely on dot-product and absolute difference computations, typically performed by multiply-accumulate (MAC) operations. Large neural networks face challenges due to the impracticality of storing vast data in processor caches, leading to data transfer bottlenecks. CIM circuits conduct operations locally within memory, reducing data movement between memory and the processor, enhancing throughput, and minimizing energy consumption. CIM devices feature a memory array storing weights, with an input driver generating input signals. The device performs logical operations on selected weights and input signals, including MAC operations, enhancing computational efficiency.

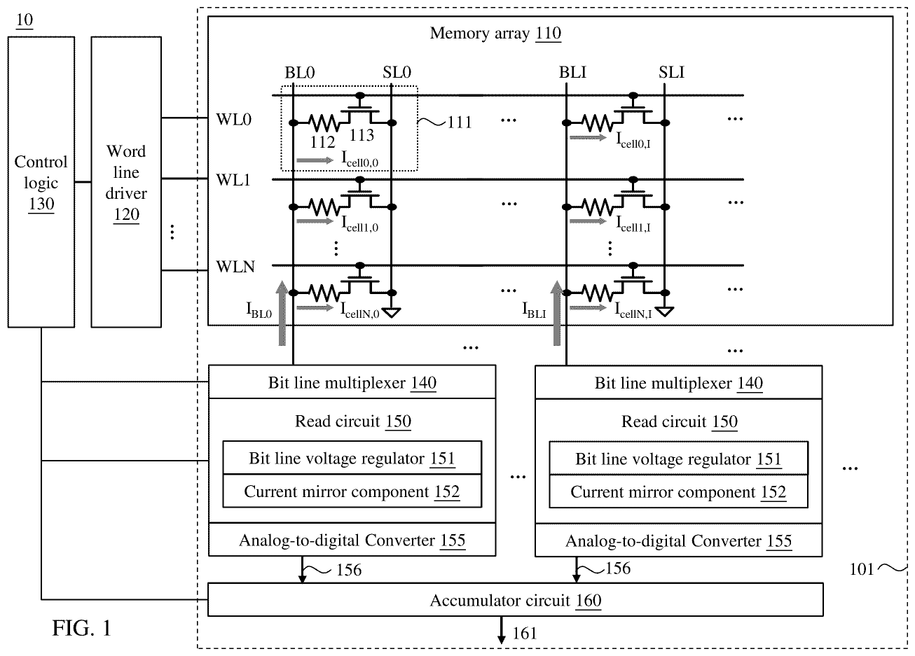

Reference is now made to FIG. 1. FIG. 1 is a schematic diagram of a memory device 10 in accordance with some embodiments of the present disclosure. In some embodiments, the memory device 10 is configured as a compute-in-memory system (CIM) for neural network operations. For illustration, the memory device 10 includes a memory array 110, a word line driver 120, a control logic 130, a bit line multiplexer 140, a read circuit 150, and an accumulator circuit 160. In some embodiments, the memory array 110, the bit line multiplexers 140, the read circuits 150, the analog-to-digital converters 155, the accumulator circuit 160 are formed and included in a memory macro 101.

In some embodiments, the memory array 110 includes multiple memory cells 111 arranged at intersections of rows and columns, as shown in FIG. 1. In some embodiments, each memory cell 111 has a corresponding memory address XA.

In some embodiments, the memory array 110 includes resistive-based random access memory (RAM) cells, also referred to as memristor cells. For example, the memory cell 111 includes a resistive element 112 and a control transistor 113 coupled in series. For illustration, a control terminal of the control transistor 113 is coupled to a corresponding word line WL, a source/drain terminal thereof is coupled to a corresponding source line SL, and a drain/source terminal thereof is coupled to the resistive element 112. The resistive element 112 is further coupled to a corresponding bit line BL. In some embodiments, the source line SL is coupled to a voltage terminal, for example, providing a ground voltage.

The configurations of memory cells 111 in FIG. 1 are given for illustrative purposes. Various implements are within the contemplated scope of the present disclosure. For example, in some embodiments, the memory cell 111 can include resistive-RAM (ReRAM), magnetoresistive RAM (MRAM), ferroelectric RAM (FeRAM), dielectric RAM, any suitable array of any suitable memory devices, or combinations thereof.

In some embodiments, the memory array 110 is configured to store weight data. For example, the memory cell 111 is written to have a first resistance (e.g., high resistance R_{HRS}) that corresponds to a low logic value (e.g., “0”) of the weight data. On the other hand, the memory cell 111 is written to have a second resistance (e.g., low resistance R_{LRS}) that corresponds to a high logic value (e.g., “1”) of the weight data.

The word line driver (WLDR) 120 is coupled to the memory array 110 through word lines WL0-WLN. In some embodiments, the word line driver 120 is configured to activate word lines by generating word line signals on corresponding word lines WL0-WLN according to received input data IN to turn on the control transistor 113 for performing computation operation (also referred to as a multiply-and-accumulation (MAC) operation) on input data IN and the weight data WT store in the memory cells 111. In some embodiments, each memory cell 111 generates an output current I_{cell} according to a weight bit stored therein and the word line signal associated with the input data IN, as shown in Table I below.

TABLE I

| Input data | Weight data | | | |
|---|---|---|---|---|
| (IN) | (WT) | Cell resistance | Product(IN × W) | I_{cell} |
| 0 | 0 | R_{HRS} | 0 | 0 |
| 0 | 1 | R_{LRS} | 0 | 0 |
| 1 | 0 | R_{HRS} | 0 | I_{HRS} |
| 1 | 1 | R_{LRS} | 1 | I_{LRS} |

For example, in some embodiments, the word line driver 120 generates a word line signal having a high logic state in response to a bit X₀ of the input data IN having bit value “1”. Then, the memory cell 111 generates the current I_{cell} according to a weight bit having the resistance R_{LRS} (corresponding to the logic value “1”) and the word line signal associated with the input data IN. Accordingly, based on the Table I, the current I_{cell} has a value I_{LRS} and corresponds to a result having the logic value “1” of the CIM operations of the input data IN and the weight data WT.

The control logic 130 is configured to control the memory array 110, the word line driver 120, the bit line multiplexers 140, the read circuits 150, and the accumulator circuit 160 to perform either traditional memory access (e.g., read and write of specific addresses), as well as CIM operation. In some embodiments, the control logic 130 includes an x-decoder for the word lines and a y-decoder for the bit lines. It also contains timing control for read, write, and computation operations.

The bit line multiplexers (MUX) 140 are coupled to the memory array 110 through bit lines. In some embodiments, the bit line multiplexer 140 is an 8-to-1 multiplexer that couples to eight, for example, bit lines BL0-BL7, in the bit lines and electrically connects a selected one of eight bit lines to the read circuit 150 in response to control signal from the control logic 130. Alternatively stated, in some embodiments, every eight columns of the memory cells 111 and eight bit lines share one bit line multiplexer 140 and one read circuit 150 along with an analog-to-digital converter 155, as shown in FIG. 1.

In some embodiments, a certain number of the memory cells 111 contribute the currents (e.g, Icell_{0,0}-Icell_{N,0}). The read circuit 150 in the same column provides a read voltage VBL to selected bit line to sense a current (e.g., I_{BL0}) as a summation of all current provided by the memory cells 111 in that column. The read circuit 150 further mirrors the current I_{BL0} to the analog-to-digital converter 155, in which the bit line current corresponds to an analog output result data of MAC operation on the input data IN and the weight data WT of the column.

In some embodiments of FIG. 1, the read circuit 150 includes a bit line voltage circuit 151 and a current mirror component 152 coupled between the bit line voltage circuit 151 and the analog-to-digital converter 155. The bit line voltage circuit 151 is configured to generate a read (bit line) voltage to a selected bit line through the bit line multiplexer 140 in the computation operation. The current mirror component 152 is configured to mirror the current, for example, the I_{BL0} to the analog-to-digital converter 155.

The analog-to-digital converter 155 is configured to convert the analog current mirrored from the sum current to a digital signal 156 to the accumulator circuit 160.

The accumulator circuit 160 is configured to accumulate the digital signals from the read circuits 150 and correspondingly generates an output 161 indicating a result of weighted sum of the input data IN and the weight data WT stored in the memory array 110. In some embodiments, the accumulator circuit 160 provides the functional units, such as an adder, multiplier, register, etc.

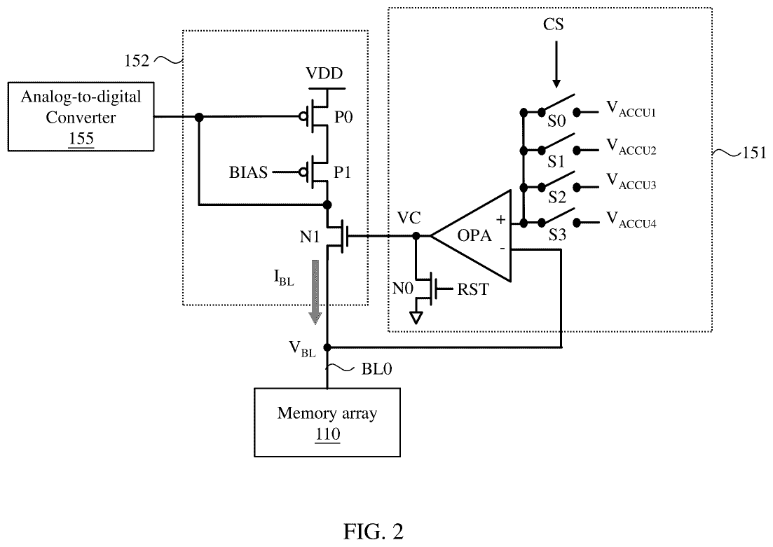

Reference is now made to FIG. 2. FIG. 2 is a schematic diagram of the read circuit 150 in the memory device 10 shown in FIG. 1, in accordance with some embodiments of the present disclosure. The configurations of all read circuits 150 are similar to each other. Hence, only one read circuit 150 is given as an example for descriptions.

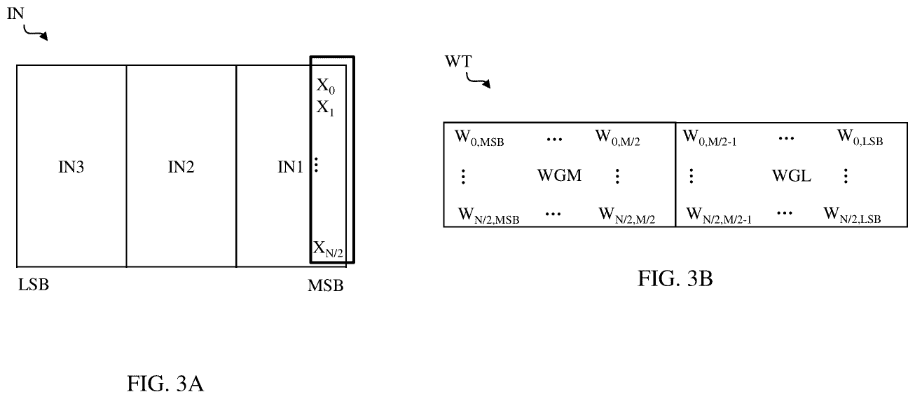

The read circuit 150 is configured to generate, in response to a control signal CS, a read voltage V_{BL} based on selected reference voltage in reference voltages V_{ACCU1}-V_{ACCU4}. In some embodiments, the control logic 130 in FIG. 1 generates the control signal based on portions in the input data IN being inputted to the memory array 110 and row addresses XA of portions in the weight data WT being accessed in the MAC operations. The detailed configurations will be discussed with references to the embodiments of FIGS. 3A-7F.

As illustratively shown in FIG. 2, the bit line voltage circuit 151 includes switches S0-S3, an operational amplifier OPA, and an N-type transistor N0. The switches S0-S3 have first terminals receiving the reference voltages V_{ACCU1}-V_{ACCU4} separately and second terminals coupled to a first input (e.g., a positive input) of the operational amplifier OPA. The output of the operational amplifier OPA is coupled to a drain/source terminal of the transistor N0. A second input (e.g., a negative input) of the operational amplifier OPA is coupled to the bit line, for example, BL0 to receive the read voltage V_{BL}. The source/drain terminal of the transistor NO is coupled to a supply voltage terminal, for example, a ground. The gate terminal of the transistor NO receives a signal RST.

In operation of the MAC operation, the transistor N0 is turned off to disconnect the ground with the output of the operational amplifier OPA in response to the signal RST having a low logic value (e.g, “0”). One of the switches S0-S3 is turned on in response to the control signal CS to transmit one of the reference voltages V_{ACCU1}-V_{ACCU4} to the first input of the operational amplifier. The operational amplifier OPA generates a control voltage VC based on the transmitted reference voltage and the read voltage V_{BL} fed back to the second input thereof.

The current mirror component 152 includes P-type transistors P0-P1 and an N-type transistor N1 coupled in series between the bit line BL0 and a supply voltage terminal providing a supply voltage VDD. For illustration, a source/drain terminal of the transistor P0 is coupled to the supply voltage terminal, a gate terminal of the transistor P0 is coupled to a drain/source terminal of the transistor P1, and a drain/source terminal of the transistor P0 is coupled to a source/drain terminal of the transistor P1. In some embodiments, the gate terminal of the transistor P0 is further coupled to the analog-to-digital converter 155. The drain/source terminal of the transistor P1 is coupled to a source/drain terminal of the transistor N1, and a gate terminal of the transistor P1 receives a signal BIAS. The source/drain terminal of the transistor N1 is coupled to the bit line and the second input of the operational amplifier OPA. The gate terminal of the transistor NI is coupled to the output of the operational amplifier.

In operation of the MAC operation, the transistor P1 operates in the saturation region in response to the signal BIAS. The transistor N1 is controlled by the control voltage VC to generate the read voltage V_{BL}. As discussed previously with respect to FIG. 1, the control logic 130 controls the memory array 110 to perform MAC operation on the input data IN and the weight data WT to generate the current I_{BL} on the bit line. The current mirror component 152 is further configured to be a part of a current mirror to mirror the current IBL to the analog-to-digital converter 155.

The configurations of FIG. 2 are given for illustrative purposes. Various implements are within the contemplated scope of the present disclosure. For example, in some embodiments, the analog-to-digital converter 155 is any suitable analog-to-digital converter to digitalize the current I_{BL}. For example, the analog-to-digital converter 155 is a 5-bit analog-to-digital converter.

In some embodiments, during other memory operations of the memory device 10, the signal RST has a high logic value (e.g., “1”) to pull the control voltage VC to the ground.

Reference is now made to FIG. 3A. FIG. 3A is a schematic diagram of the input data IN, in accordance with some embodiments of the present disclosure.

In some embodiments, the input data IN is an input matrix including multiple binary numbers, in which the rightmost part are most significant bits (MSB) and the leftmost part are least significant bits (LSB).

In some embodiments, the input data IN input into the memory array 110 are in form of input word vectors each including several elements, for example, X₀ to X_{N/2}, and are inputted according an order from the input word vector including the MSB to the input word vector including the LSB. For example, input data IN has three portions IN1-IN3, which are sequentially input to the memory array 110 by the word line driver 120.

Reference is now made to FIG. 3B. FIG. 3B is schematic diagram of the weight data WT, in accordance with some embodiments of the present disclosure.

In some embodiments, the weight data WT is a weight matrix including weight data (bits) W_{0,MSB} to W_{N/2,LSB}. The weight data W_{0,MSB} to W_{N/2,MSB} in a portion WGM of the weight data WT correspond to the MSB of the weight data WT. The weight data W_{0,LSB} to W_{N/2,LSB} in a portion WGL of the weight data WT correspond to the LSB of the weight data WT.

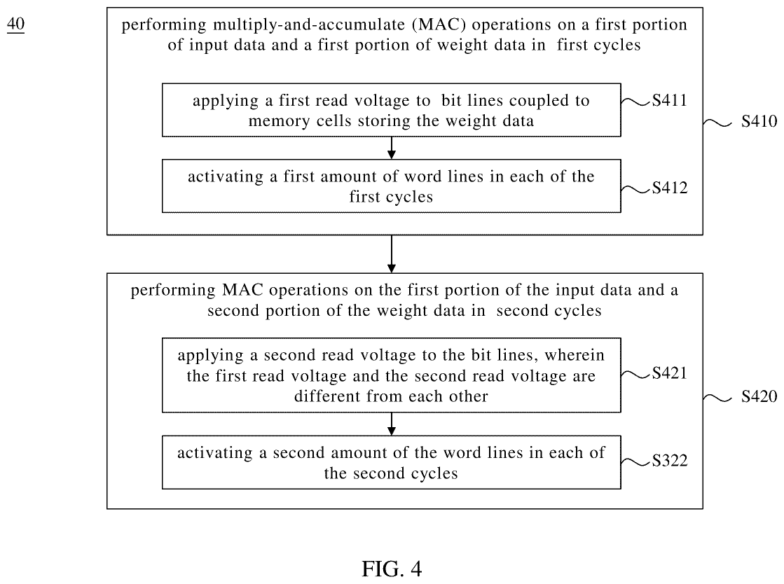

Reference is now made to FIG. 4. FIG. 4 is a flowchart of a method 40 of operating a memory device, in accordance with some embodiments of the present disclosure. It is understood that additional operations can be provided before, during, and after the processes shown by FIG. 4, and some of the operations described below can be replaced or eliminated, for additional embodiments of the method 40. The order of the operations/processes may be interchangeable. Throughout the various views and illustrative embodiments, like reference numbers are used to designate like elements. The method 30 includes operations S410 and S420 that are described below with reference to the memory devices 10, 60, and 70 corresponding to FIGS. 1-7F.

In some embodiments, the method 40 is performed to generate MAC operation results by applying a weighted sum (dot product) between a portion of the input data IN and a portion of the weight data WT at a time, and so on.

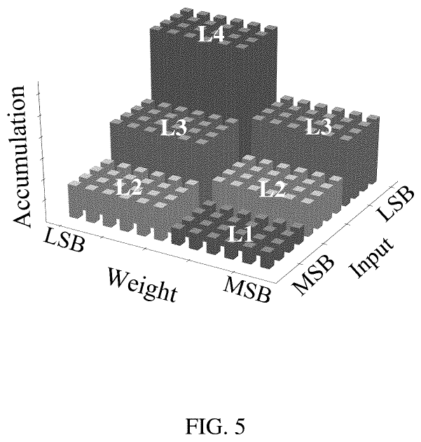

For example, as shown in FIG. 5 depicting a schematic diagram of the input data IN, the weight data WT, and accumulation numbers, MAC operations on the portion IN1 and the portion WGM correspond to an operation level L1 of operation, and the operation level L1 indicates that an accumulation number N_{ACCU1} of elements in the input data IN are input to the memory array 110 in every cycle of MAC operations. Similarly, MAC operations on the portion IN1 and the portion WGL and MAC operations on the portion IN2 and the portion WGM correspond to an operation level L2. The operation level L2 indicates that an accumulation number N_{ACCU2} of elements in the input data IN are input to the memory array 110 in every cycle of MAC operations. MAC operations on the portion IN2 and the portion WGL and MAC operations on the portion IN3 and the portion WGM correspond to an operation level L3. The operation level L3 indicates that an accumulation number N_{ACCU3} of elements in the input data IN are input to the memory array 110 in every cycle of MAC operations. MAC operations on the portion IN3 and the portion WGL correspond to an operation level L4, and the operation level L4 indicates that an accumulation number N_{ACCU4} of elements in the input data IN are input to the memory array 110 in every cycle of MAC operations.

The accumulation numbers N_{ACCU1} to N_{ACCU4} are different from each other. In some embodiments, the read circuit 150 generates read voltage V_{BL} to have different voltage levels for the operation levels L1-L4. In some embodiments, the accumulation numbers N_{ACCU1} to N_{ACCU4}, the read voltage V_{BL}, the current Icell from a single memory cell 111, ranges of current I_{BL} are given as shown in Table II below:

Table II

| | N_{ACCU1}- | | | |
|---|---|---|---|---|
| Level | N_{ACCU4} | V_{BL} | I_{cell} | I_{BL} |
| L1 | 16 | V_{BL1} | I_{cell} | 16 × I_{HRS} to 16 × I_{LRS}, 0 |
| L2 | 32 | ${V}_{BL 2} = ( \frac{1}{2} ) {V}_{BL 1}$ | $( \frac{1}{2} ) {I}_{cell}$ | $32 \times ( \frac{1}{2} ) {I}_{HRS} to 32 \times ( \frac{1}{2} ) {I}_{LRS} , 0$ |
| L3 | 64 | ${V}_{BL 3} = ( \frac{1}{4} ) {V}_{BL 1}$ | $( \frac{1}{4} ) {I}_{cell}$ | $64 \times ( \frac{1}{4} ) {I}_{HRS} to 64 \times ( \frac{1}{4} ) {I}_{LRS} , 0$ |
| L3 | 128 | ${V}_{BL 4} = ( \frac{1}{8} ) {V}_{BL 1}$ | $( \frac{1}{8} ) {I}_{cell}$ | $128 \times ( \frac{1}{8} ) {I}_{HRS} to 128 \times ( \frac{1}{8} ) {I}_{LRS} , 0$ |

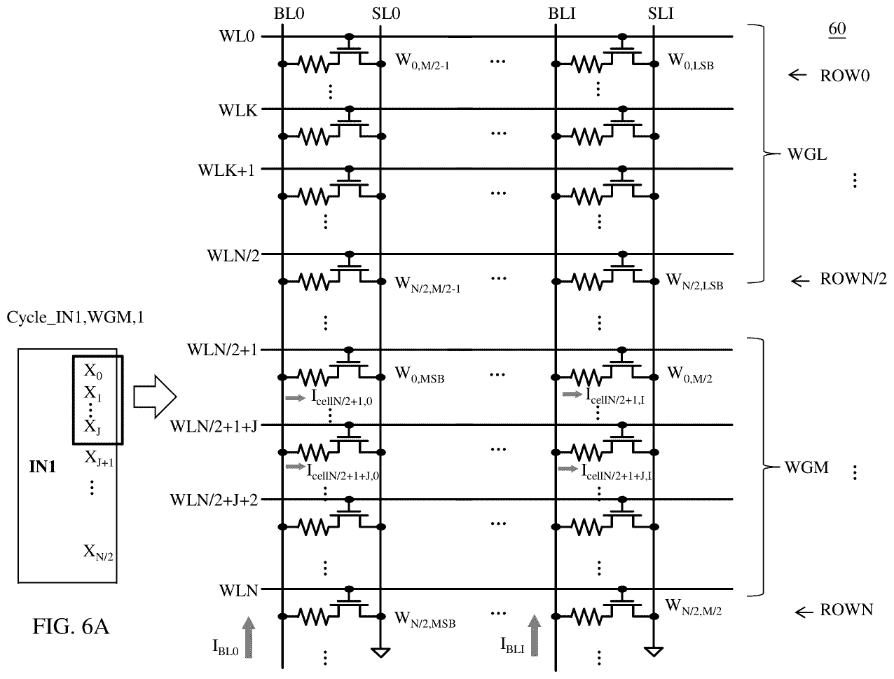

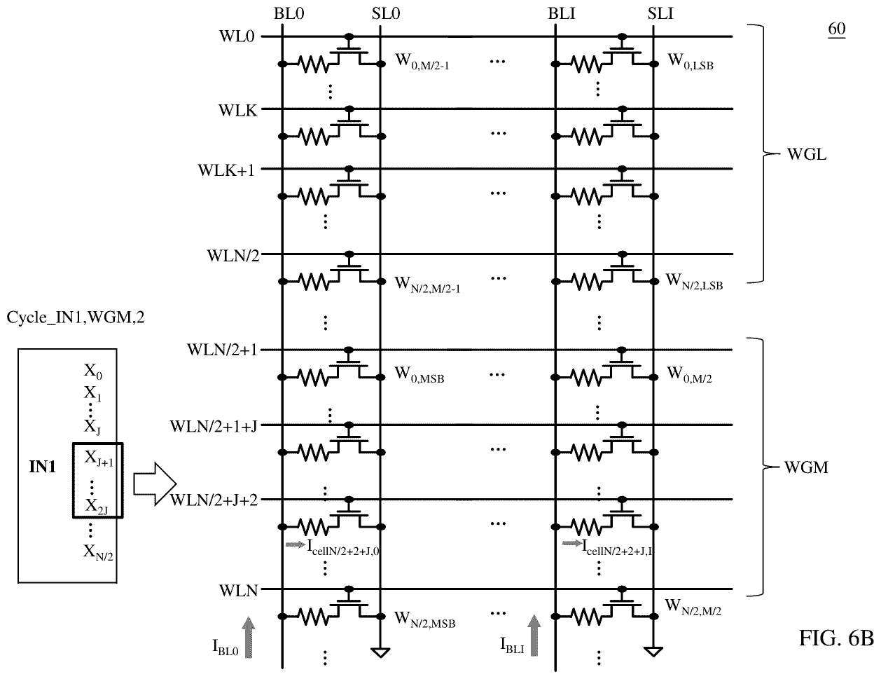

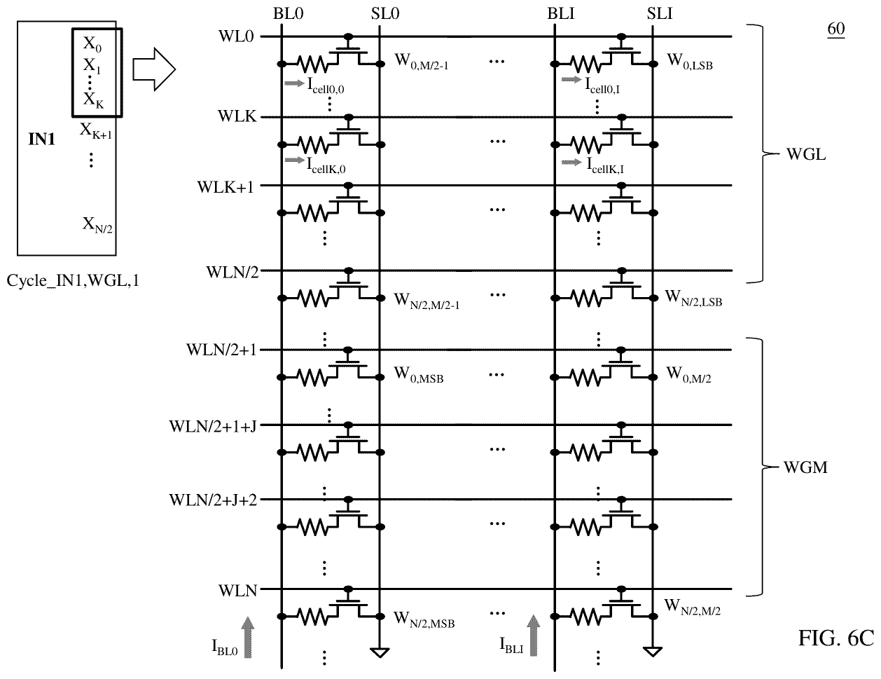

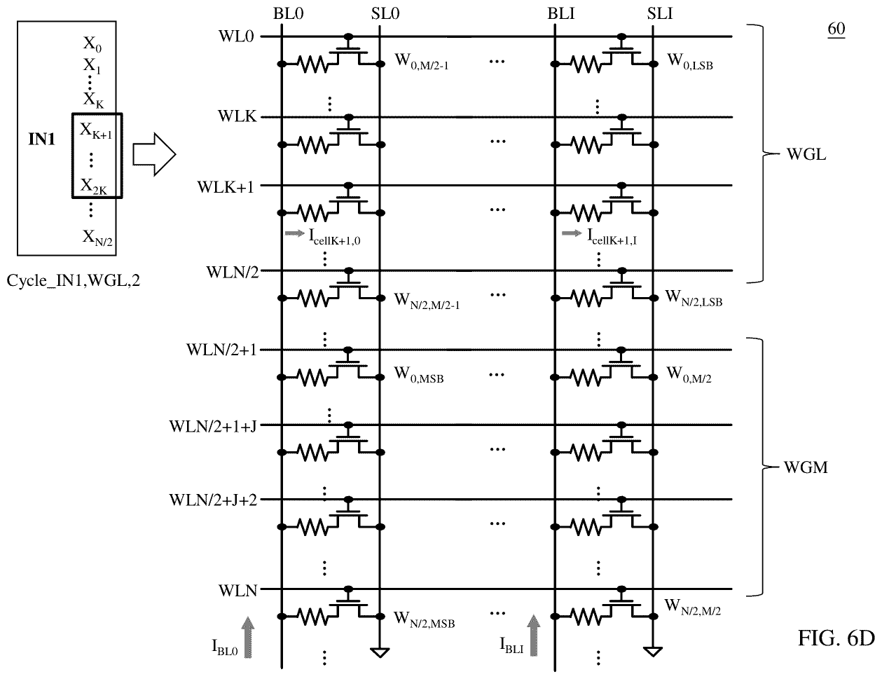

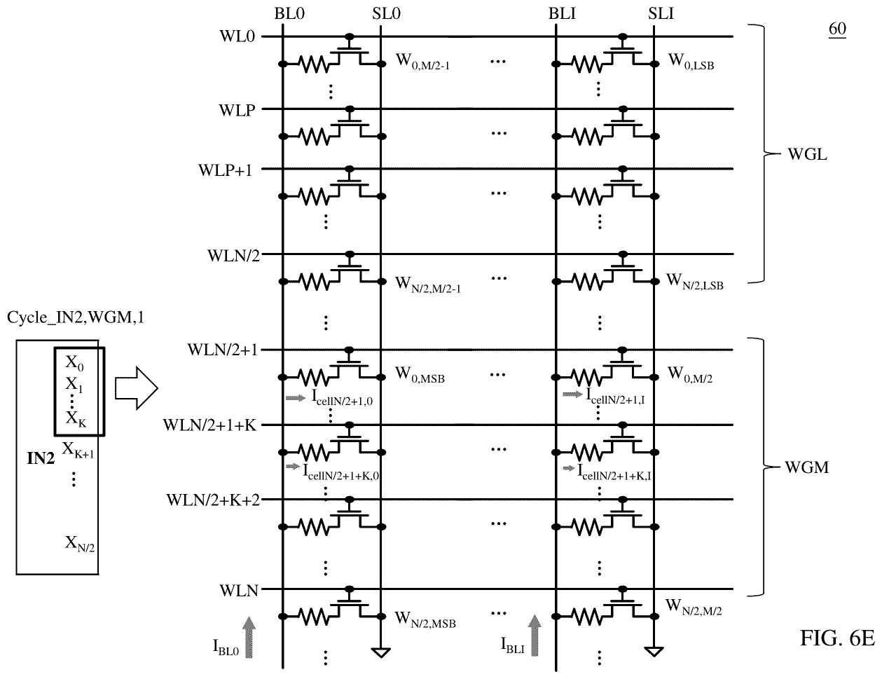

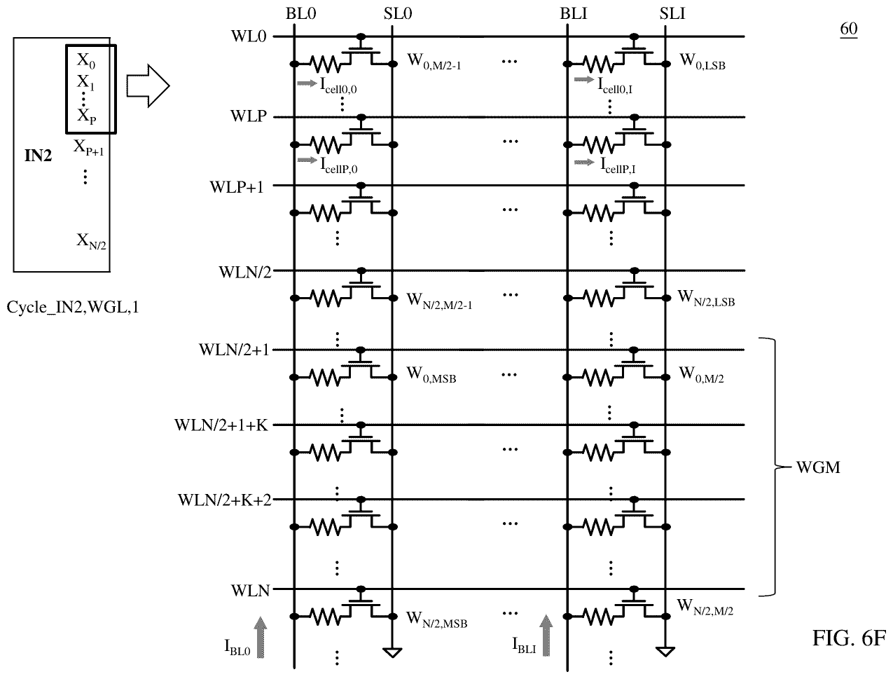

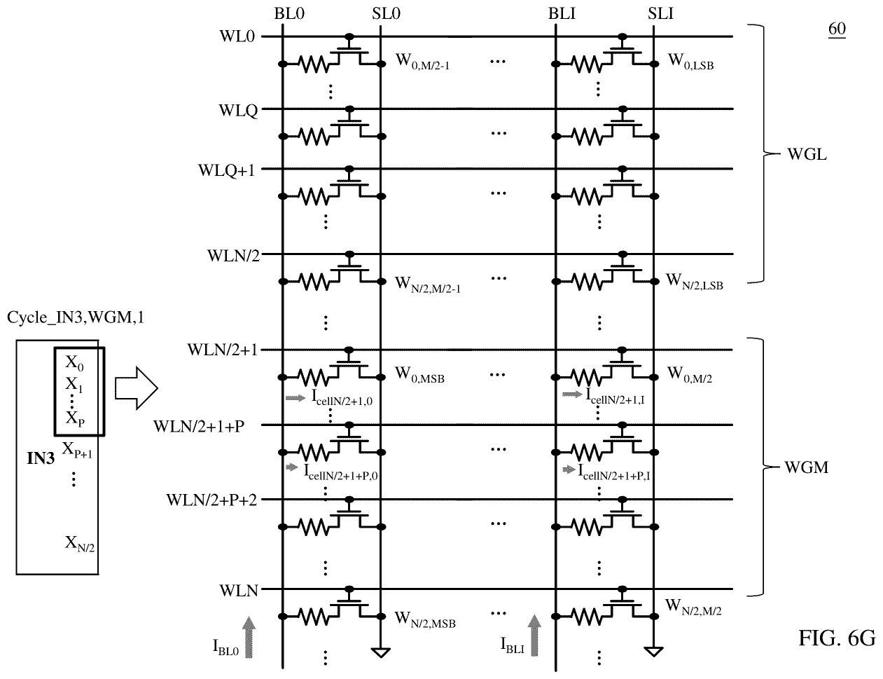

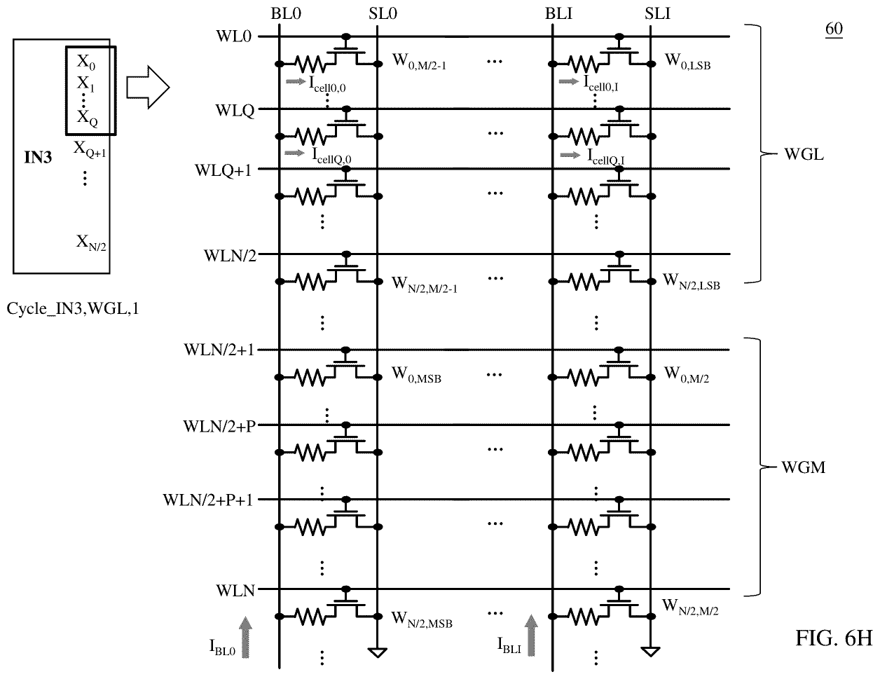

For detailed operations of the method 40, reference is now made to FIGS. 4 and 6A. As shown in FIG. 6A, a memory device 60 is configured with respect to, for example, the memory device 10 of FIG. 1. With respect to the embodiments of FIGS. 1-5, like elements in FIG. 6A are designated with the same reference numbers for ease of understanding. The specific operations of similar elements, which are already discussed in detail in above paragraphs, are omitted herein for the sake of brevity.

The memory device 60 includes the memory cell 111 arranged in N rows and I columns to store the weight data WT illustrated in FIG. 3B. For illustration, the portion WGL are stored in the memory cells 111 that are in the rows ROW0-ROWN/2 and coupled to the word lines WL0-WLN/2. For example, the weight data W_{0,M/2-1} to W_{N/2,M/2-1} are stored in the memory cell 111 coupled to the bit line BL0 and the source line SL0, the weight data W_{0,LSB} to W_{N/2,LSB} are stored in the memory cell 111 coupled to the bit line BLI and the source line SLI, and so on. Numbers “N”, “M”, and “I” are positive integers.

The portion WGM are stored in the memory cells 111 that are in the rows ROWN/2+1-ROWN and coupled to the word lines WLN/2+1−WLN. For example, the weight data W_{0,MSB} to W_{N/2,MSB} are stored in the memory cell 111 coupled to the bit line BL0 and the source line SL0, the weight data W_{0,M/2} to W_{N/2,M/2} are stored in the memory cell 111 coupled to the bit line BLI and the source line SLI, and so on.

In operation S410, MAC operations are performed on the portion IN1 of the input data IN and the portion WGM of the weight data WT in first operation cycles. For example, in step S411 in operation S410, with reference to Table II and FIG. 6A, the read voltage V_{BL} having a voltage V_{BL1} is applied to the bit lines BL0-BLI through the read circuits 150. In some embodiments, the voltage V_{BL1} is generated based on the reference voltage V_{ACCU1}.

Furthermore, in step S412 in operation S410, for example, in each of cycle in the first operation cycles, a number equal to the accumulation number N_{ACCU1} of elements, for example, 16 elements in the portion IN1 are input to the memory array 110 through a number equal to the accumulation number N_{ACCU1} of word lines while the other word lines are deactivated.

For example, as shown in FIG. 6A, in a first cycle Cycle_IN1, WGM, 1 in the first operation cycles, elements X₀-X_{J} are input to the word lines WLN/2+1 to WLN/2+1+J respectively while rest of the word lines, for example, WL0-WLN/2 and WLN/2+J+2 to WLN are disactivated, “J” being 15. In the embodiments above, the word lines WLN/2+1 to WLN/2+1+J are referred to as “activated word lines”. Accordingly, the corresponding memory cells 111 coupled to the activated word lines generate current, for example, Icell_{N/2+1,0} to Icell_{N/2+1+J,0} in the first column to provide the current I_{BL0} and Icell_{N/2+1,I} to Icell_{N/2+1+J,I} in the last column to provide the current I_{BLI}, and so on. Based on the stored weight data and the input word element, the current I_{BL0}-I_{BLI} range between 16×I_{HRS} and 16×I_{LRS} or zero, as shown in Table II.

In a second cycle Cycle_IN1, WGM,2 in the first operation cycles, elements X_{J+1}−X_{2J} are input to the word lines WLN/2+J+2 to WLN/2+1+2J respectively while rest of the word lines, for example, WL0-WLN/2+1+J and WLN/2+2J+2 to WLN are disactivated. Similarly, the corresponding memory cells 111 coupled to the activated word lines generate current, for example, Icell_{N/2+2+J,0} to Icell_{N/2+1+2J,0} in the first column to provide the current I_{BL0} and Icell_{N/2+2+J,I} to Icell_{N/2+1+2J,I} in the last column to provide the current I_{BLI}, and so on. The configurations of following cycles in the first operation cycles are similar to the first and second cycles mentioned above. Hence, the repetitious descriptions are omitted here.

The read circuits 150 continuously sense the I_{BL0}-I_{BLI} in numerous first operation cycles until all MAC operations performed on the portion IN1 of the input data IN and the portion WGM of the weight data WT finished.

Then, in operation S420, MAC operations are performed on the portion IN1 of the input data IN and the portion WGL of the weight data WT in second operation cycles. For example, in step S421 in operation S420, with reference to Table II and FIG. 6C, the read voltage V_{BL} having a voltage V_{BL2} is applied to the bit lines BL0-BLI through the read circuits 150. In some embodiments, the voltage V_{BL2} is generated based on the reference voltage V_{ACCU2}. In some embodiments, the reference voltage V_{ACCU2} is smaller than the reference voltage V_{ACCU1}, the voltage V_{BL2} and equals to half of the voltage V_{BL1}.

Furthermore, in step S422 in operation S420, for example, in each of cycle in the second operation cycles, a number equal to the accumulation number N_{ACCU2} of elements, for example, 32 elements in the portion IN1 are input to the memory array 110 through a number equal to the accumulation number N_{ACCU2} of word lines while the other word lines are deactivated.

For example, as shown in FIG. 6C, in a first cycle Cycle_IN1, WGL,1 in the second operation cycles, elements X₀-X_{K} are input to the word lines WL0 to WLK respectively while rest of the word lines, for example, WLK+1 to WLN are disactivated, “K” being 31. In the embodiments above, the word lines WL0 to WLK are referred to as “activated word lines”. Accordingly, the corresponding memory cells 111 coupled to the activated word lines generate currents, for example, Icell_{0,0} to Icell_{K,0} in the first column to provide the current I_{BL0} and I_{cell0,I} to I_{cellK,I} in the last column to provide the current I_{BLI}, and so on. Based on the stored weight data and the input word element, the current I_{BL0}-I_{BLI} range between

$$32 \times ( \frac{1}{2} ) {I}_{HRS}$$

to

$$32 \times ( \frac{1}{2} ) {I}_{LRS}$$

or zero, as shown in Table II. Alternatively stated, the range of the current I_{BL} is the same in the level L1 and level L2 of operation. In some embodiments, the current I_{cell} generated by the memory cell 111 in the level L2 of operation is half of the current I_{cell} generated by the memory cell 111 in the level L1 of operation when the memory cells 111 have same resistance.

As shown in FIG. 6D, in a second cycle Cycle_IN1, WGL,2 in the second operation cycles, elements X_{K+1}-X_{2K} are input to the word lines WLK+1 to WL2K respectively while rest of the word lines, for example, WL0-WLK and WL2K+1 to WLN are disactivated. Similarly, the corresponding memory cells 111 coupled to the activated word lines generate current, for example, Icell_{K+1,0} to I_{cell2K,0} in the first column to provide the current I_{BL0} and I_{cellK+1,I} to I_{cell2K,I} in the last column to provide the current I_{BLI}, and so on. The configurations of following cycles in the second operation cycles are similar to the first and second cycles mentioned above. Hence, the repetitious descriptions are omitted here.

The read circuits 150 continuously sense the I_{BL0}-I_{BLI} in numerous second operation cycles until all MAC operations performed on the portion IN1 of the input data IN and the portion WGL of the weight data WT finished.

The method 40 further includes operations of performing MAC operations on the portion IN2 of the input data IN and the portion WGM of the weight data WT in third operation cycles, as one of the third operation cycles being shown in FIG. 6E. The configurations are similar to those of MAC operations on the portion IN1 of the input data IN and the portion WGM. The differences are that the read voltage V_{BL} having the voltage V_{BL2} and that in each of cycle in the third operation cycles, a number equal to the accumulation number N_{ACCU2} of elements in the portion IN2 are input to the memory array 110 through a number equal to the accumulation number N_{ACCU2} of word lines while the other word lines are deactivated.

The read circuits 150 continuously sense the I_{BL0}-I_{BLI} in numerous third operation cycles until all MAC operations performed on the portion IN2 of the input data IN and the portion WGM of the weight data WT finished.

The method 40 further includes operations of performing MAC operations on the portion IN2 of the input data IN and the portion WGL of the weight data WT in fourth operation cycles, as a first cycle Cycle_IN2, WGL,1 of the fourth operation cycles being shown in FIG. 6F. With reference to FIG. 5, the MAC operations correspond to the level L3 of operation.

Specifically, with reference to Table II and FIG. 6F, the read voltage V_{BL} having a voltage V_{BL3} is applied to the bit lines BL0-BLI through the read circuits 150. In some embodiments, the voltage V_{BL3} is generated based on the reference voltage V_{ACCU3}. In some embodiments, the reference voltage V_{ACCU3} is smaller than the reference voltage V_{ACCU2}, the voltage V_{BL3} and equals to one fourth of the voltage V_{BL1}.

Furthermore, in each of cycle in the second operation cycles, a number equal to the accumulation number N_{ACCU3} of elements, for example, 64 elements in the portion IN2 are input to the memory array 110 through a number equal to the accumulation number N_{ACCU3} of word lines while the other word lines are deactivated.

For example, as shown in FIG. 6F, elements X₀-X_{P} are input to the word lines WL0 to WLP respectively while rest of the word lines, for example, WLP+1 to WLN are disactivated, “P” being 63. In the embodiments above, the word lines WL0 to WLP are referred to as “activated word lines”. Accordingly, the corresponding memory cells 111 coupled to the activated word lines generate currents, for example, I_{cell0,0} to I_{cellP,0} in the first column to provide the current I_{BL0} and I_{cello,I} to I_{cellP,I} in the last column to provide the current I_{BLI}, and so on. Based on the stored weight data and the input word element, the current I_{BL0}-I_{BLI} range between

$$64 \times ( \frac{1}{4} ) {I}_{HRS}$$

to

$$64 \times ( \frac{1}{4} ) {I}_{LRS}$$

or zero, as shown in Table II. Alternatively stated, the range of the current IBL is the same in the levels L1, L2, and 3 of operation. In some embodiments, the current I_{cell} generated by the memory cell 111 in the level L3 of operation is one fourth of the current I_{cell} generated by the memory cell 111 in the level L1 of operation when the memory cells 111 have same resistance.

The read circuits 150 continuously sense the I_{BL0}-I_{BLI} in numerous fourth operation cycles until all MAC operations performed on the portion IN2 of the input data IN and the portion WGL of the weight data WT finished.

The method 40 further includes operations of performing MAC operations on the portion IN3 of the input data IN and the portion WGM of the weight data WT in fifth operation cycles, as one of the third operation cycles being shown in FIG. 6G. The configurations are similar to those of MAC operations on the portion IN2 of the input data IN and the portion WGM. The differences are that the read voltage V_{BL} having the voltage V_{BL3} and that in each of cycle in the fifth operation cycles, a number equal to the accumulation number N_{ACCU3} of elements in the portion IN3 are input to the memory array 110 through a number equal to the accumulation number N_{ACCU3} of word lines while the other word lines are deactivated.

The read circuits 150 continuously sense the I_{BL0}-I_{BLI} in numerous fifth operation cycles until all MAC operations performed on the portion IN3 of the input data IN and the portion WGM of the weight data WT finished.

The method 40 further includes operations of performing MAC operations on the portion IN3 of the input data IN and the portion WGL of the weight data WT in sixth operation cycles, as a first cycle Cycle_IN3, WGL,1 of the sixth operation cycles being shown in FIG. 6H. With reference to FIG. 5, the MAC operations correspond to the level L4 of operation.

Specifically, with reference to Table II and FIG. 6H, the read voltage V_{BL} having a voltage V_{BL4} is applied to the bit lines BL0-BLI through the read circuits 150. In some embodiments, the voltage V_{BL4} is generated based on the reference voltage V_{ACCU4}. In some embodiments, the reference voltage V_{ACCU4} is smaller than the reference voltage V_{ACCU4}, the voltage V_{BL4} and equals to one eighth of the voltage V_{BL1}.

Furthermore, in each of cycle in the sixth operation cycles, a number equal to the accumulation number N_{ACCU4} of elements, for example, 128 elements in the portion IN3 are input to the memory array 110 through a number equal to the accumulation number N_{ACCU4} of word lines while the other word lines are deactivated.

For example, as shown in FIG. 6H, elements X₀-X_{Q} are input to the word lines WL0 to WLQ respectively while rest of the word lines, for example, WLQ+1 to WLN are disactivated, “P” being 127. In the embodiments above, the word lines WL0 to WLQ are referred to as “activated word lines”. Accordingly, the corresponding memory cells 111 coupled to the activated word lines generate currents, for example, I_{cell0,0} to I_{cellQ,0} in the first column to provide the current I_{BL0} and I_{cell0,I} to I_{cellQ,I} in the last column to provide the current I_{BLI}, and so on. Based on the stored weight data and the input word element, the current I_{BL0}-I_{BLI} range between

$$128 \times ( \frac{1}{8} ) {I}_{HRS}$$

to

$$128 \times ( \frac{1}{8} ) {I}_{LRS}$$

or zero, as shown in Table II. Alternatively stated, the range of the current I_{BL} is the same in the levels L1, L2, L3, and L4 of operation. In some embodiments, the current I_{cell} generated by the memory cell 111 in the level L3 of operation is one eighth of the current I_{cell} generated by the memory cell 111 in the level L1 of operation when the memory cells 111 have same resistance.

The read circuits 150 continuously sense the I_{BL0}-I_{BLI} in numerous fourth operation cycles until all MAC operations performed on the portion IN3 of the input data IN and the portion WGL of the weight data WT finished.

Based on the disclosure above, as less number of elements of the input data IN are input to the memory array 110 in a single cycle of MAC operation, more cycles of MAC operations are performed in the level L1 of operation than in the levels L2, L3, and L4. Specifically, the level L1 has the highest number of cycles, followed by the level L2, the level L3 and the level L4.

Furthermore, in some embodiments, the analog-to-digital converter 155 is the 5-bit converter. Accordingly, the level L1 of operation (corresponding to the accumulation number N_{ACCU1} equal to 16) and the level L2 of operation (corresponding to the accumulation number N_{ACCU2} equal to 32) have full precision in converting the current I_{BL} for digitalized MAC operation result. For the level L3 of operation (corresponding to the accumulation number N_{ACCU3} equal to 64), every two levels of current I_{BL} correspond to a same value of MAC operation result. Similarly, For the level L4 of operation (corresponding to the accumulation number N_{ACCU4} equal to 128), every four levels of current I_{BL} correspond to a same value of MAC operation result.

In some approaches, a memory device preforms MAC operations by activating same number of word lines, for example, the accumulation number equal to 16 in every cycle.

With the configurations of the present application, by performing CIM operations in several levels of operations to input different of element of input data into the memory array, the operational speed of the CIM operations improves by at least 2.3 times. Moreover, for the levels L2, L3, and L4, greater number of the accumulation numbers N_{ACCU2} to N_{ACCU4} of word lines are activated per cycle, which highly reduces energy consumed in MAC operation. For example, for operating by the accumulation number N_{ACCU2}, energy consumption is saved by at least 1.67 times, compared to some approaches. For operating by the accumulation numbers N_{ACCU3} and N_{ACCU4}, energy consumption is saved by at least 3 times and 5.67 times respectively, compared to some approaches.

The configurations of FIGS. 4-6G are given for illustrative purposes. Various implements are within the contemplated scope of the present disclosure. For example, in some embodiments, the input data IN can be divided into more or less portions, and the weight data WT can be divided into more or less portions. Levels of operation and the read circuit 150 can be designed accordingly.

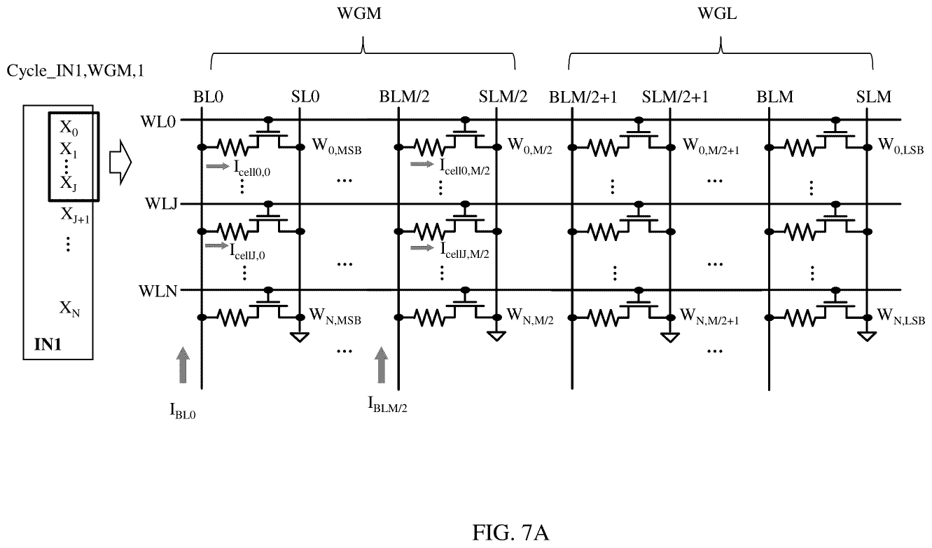

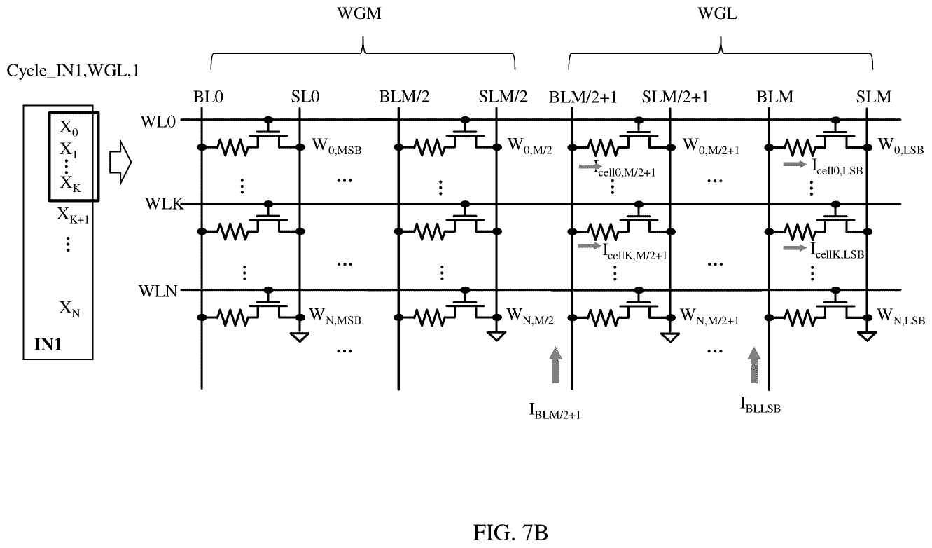

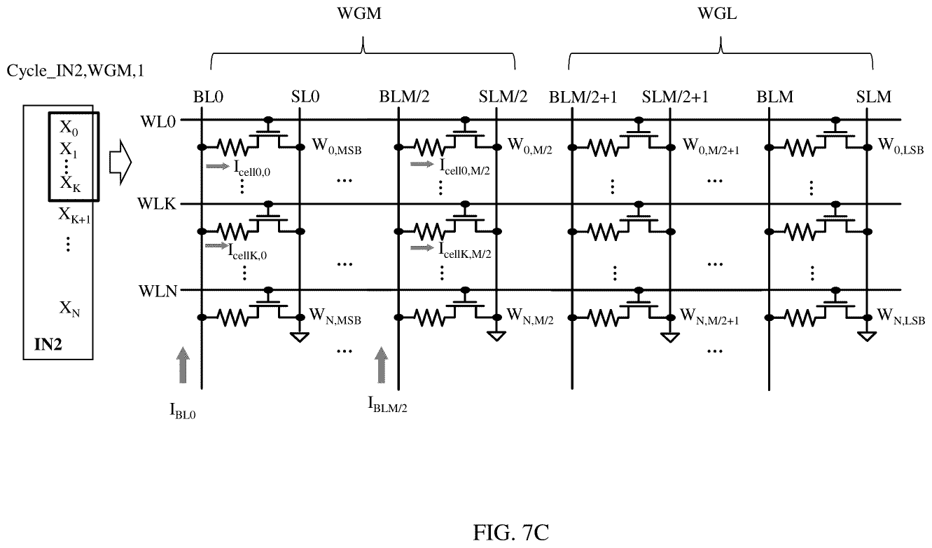

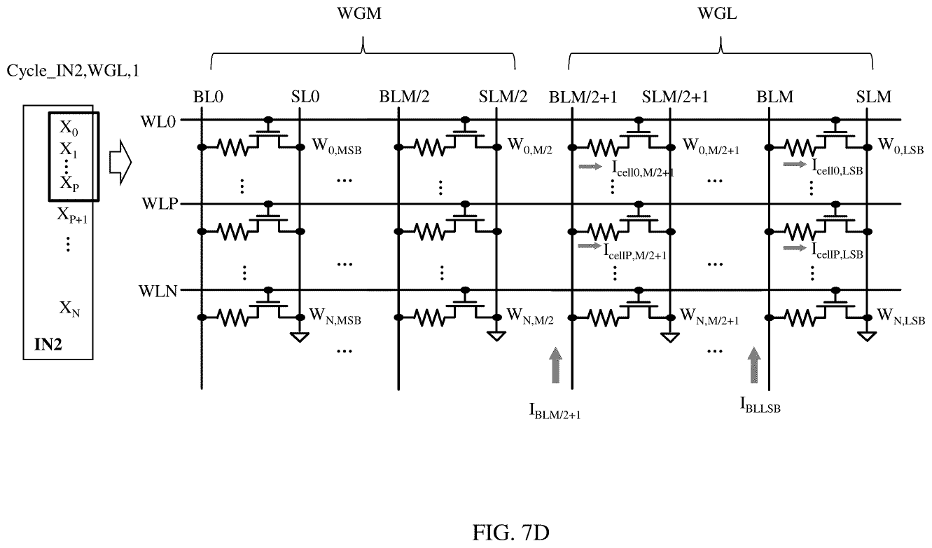

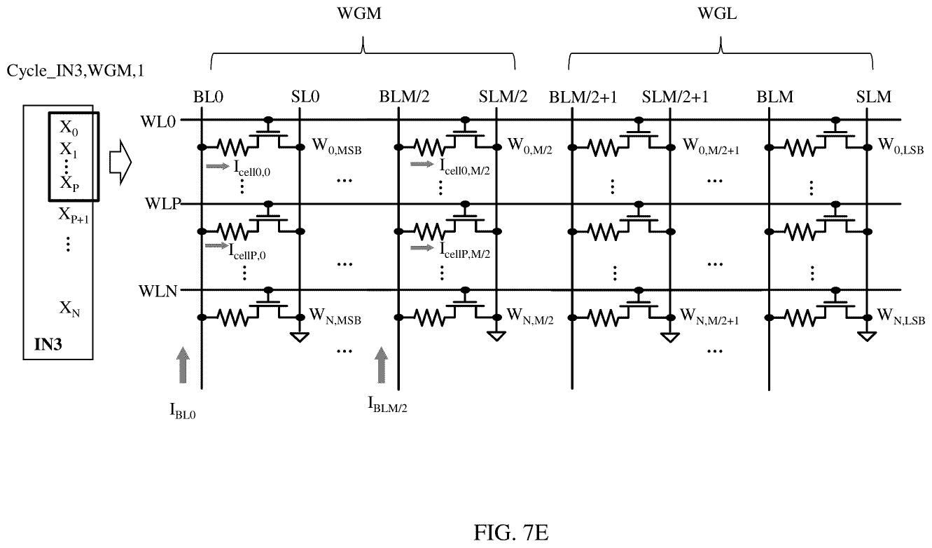

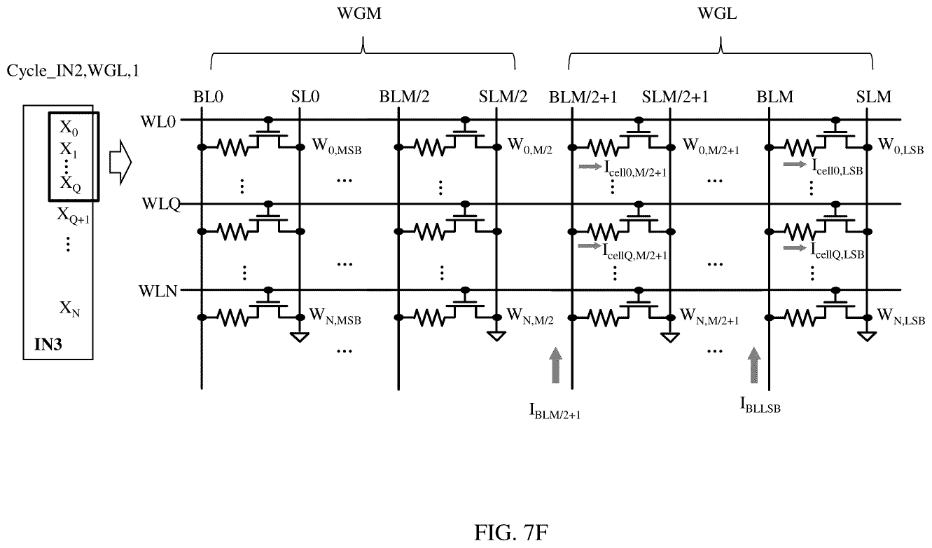

Reference is now made to FIG. 7A. FIG. 7A is schematic diagram of the memory device performing MAC operations on a portion of the input data and a portion of the weight data, in accordance with some embodiments of the present disclosure. With respect to the embodiments of FIGS. 1-6H, like elements in FIG. 7A are designated with the same reference numbers for ease of understanding. In some embodiments, the memory device 70 is configured with respect to, for example, the memory device 10 and the memory device 70.

Compared with storing the portion WGM and the portion WGL in same columns, in the embodiments of FIG. 7A, the portion WGM and the portion WGL are stored in different columns along the row direction. Specifically, the portion WGM are stored in the memory cell 111 coupled to the bit lines BL0-BLM/2, and the portion WGL are stored in the memory cell 111 coupled to the bit lines BLM/2+1-BLM.

In the embodiments of FIG. 7A showing the operation in a cycle Cycle_IN1, WGM,1, MAC operations are performed on the portion IN1 of the input data IN and the portion WGM of the weight data WT in first operation cycles. For example, with reference to Table II, the read voltage V_{BL} having the voltage V_{BL1} is applied to the bit lines BL0-BLM/2 through the read circuits 150, while the bit lines BLM/2+1-BLM are deactivated. The configurations of FIG. 7A are similar to FIG. 6A. Hence, the repetitious descriptions are omitted here.

Reference is now made to FIG. 7B. FIG. 7B is schematic diagram of the memory device performing MAC operations on the portion IN1 of the input data IN and the portion WGL of the weight data WT, in accordance with some embodiments of the present disclosure.

In the embodiments of FIG. 7B showing the operation in a cycle Cycle_IN1, WGL,1, MAC operations are performed on the portion IN1 of the input data IN and the portion WGL of the weight data WT in second operation cycles. For example, with reference to Table II, the read voltage V_{BL} having the voltage V_{BL2} is applied to the bit lines BLM/2+1-BLM through the read circuits 150, while the bit lines BL0-BLM/2 are deactivated. The configurations of FIG. 7B are similar to FIG. 6C. Hence, the repetitious descriptions are omitted here.

Reference is now made to FIG. 7C. FIG. 7C is schematic diagram of the memory device performing MAC operations on the portion IN2 of the input data IN and the portion WGM of the weight data WT, in accordance with some embodiments of the present disclosure.

In the embodiments of FIG. 7C showing the operation in a cycle Cycle_IN2, WGM,1, MAC operations are performed on the portion IN2 of the input data IN and the portion WGM of the weight data WT in third operation cycles. For example, with reference to Table II, the read voltage V_{BL} having the voltage V_{BL2} is applied to the bit lines BL0-BLM/2 through the read circuits 150, while the bit lines BLM/2+1-BLM are deactivated. The configurations of FIG. 7C are similar to FIG. 6E. Hence, the repetitious descriptions are omitted here.

Reference is now made to FIG. 7D. FIG. 7D is schematic diagram of the memory device performing MAC operations on the portion IN2 of the input data IN and the portion WGL of the weight data WT, in accordance with some embodiments of the present disclosure.

In the embodiments of FIG. 7D showing the operation in a cycle Cycle_IN2, WGL,1, MAC operations are performed on the portion IN2 of the input data IN and the portion WGL of the weight data WT in fourth operation cycles. For example, with reference to Table II, the read voltage V_{BL} having the voltage V_{BL3} is applied to the bit lines BLM/2+1-BLM through the read circuits 150, while the bit lines BL0-BLM/2 are deactivated. The configurations of FIG. 7D are similar to FIG. 6F. Hence, the repetitious descriptions are omitted here.

Reference is now made to FIG. 7E. FIG. 7E is schematic diagram of the memory device performing MAC operations on the portion IN3 of the input data IN and the portion WGM of the weight data WT, in accordance with some embodiments of the present disclosure.

In the embodiments of FIG. 7E showing the operation in a cycle Cycle_IN3, WGM,1, MAC operations are performed on the portion IN3 of the input data IN and the portion WGM of the weight data WT in fifth operation cycles. For example, with reference to Table II, the read voltage VBL having the voltage V_{BL3} is applied to the bit lines BL0-BLM/2 through the read circuits 150, while the bit lines BLM/2+1-BLM are deactivated. The configurations of FIG. 7E are similar to FIG. 6G. Hence, the repetitious descriptions are omitted here.

Reference is now made to FIG. 7F. FIG. 7F is schematic diagram of the memory device performing MAC operations on the portion IN3 of the input data IN and the portion WGL of the weight data WT, in accordance with some embodiments of the present disclosure.

In the embodiments of FIG. 7F showing the operation in a cycle Cycle_IN3, WGL,1, MAC operations are performed on the portion IN3 of the input data IN and the portion WGL of the weight data WT in fourth operation cycles. For example, with reference to Table II, the read voltage V_{BL} having the voltage V_{BL4} is applied to the bit lines BLM/2+1-BLM through the read circuits 150, while the bit lines BL0-BLM/2 are deactivated. The configurations of FIG. 7F are similar to FIG. 6H. Hence, the repetitious descriptions are omitted here.

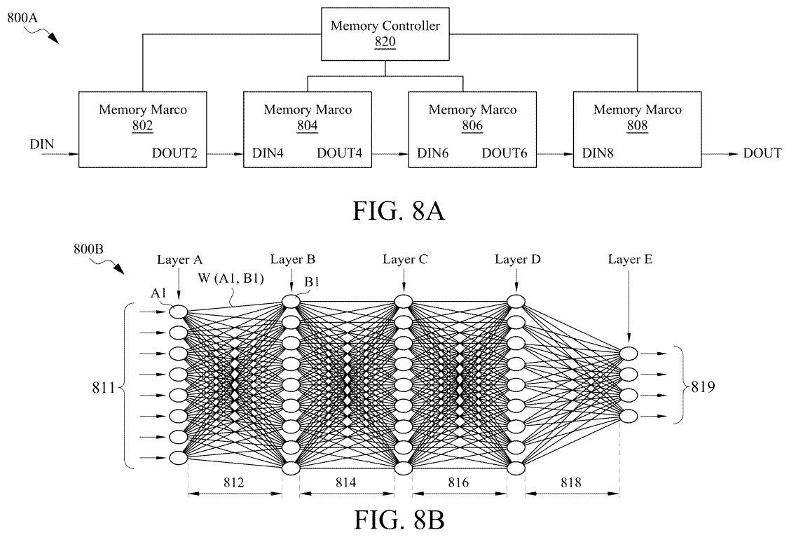

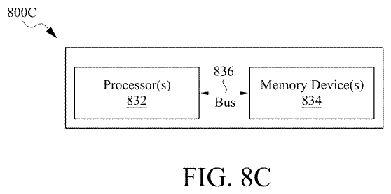

Reference is now made to FIG. 8A. FIG. 8A is a schematic diagram of a memory device 800A, in accordance with some embodiments. In some embodiments, the memory device 800A is configured with respect to, for example, the memory devices 10, 60, and 70.

The memory device 800A includes memory macros 802, 804, 806, 808 and memory controller 820. In some embodiments, one or more of the memory macros 802, 804, 806, 808 correspond to the memory macro 101, and/or the memory controller 820 corresponds to the control logic 130. In the example configuration in FIG. 8A, the memory controller 820 is a common memory controller for the memory macros 802, 804, 806, 808. In at least one embodiment, at least one of the memory macros 802, 804, 806, 808 has its own memory controller. The number of four memory macros in the memory device 800A is an example. Other configurations are within the scopes of various embodiments.

The memory macros 802, 804, 806, 808 are coupled to each other in sequence, with output data of a preceding memory macro being input data for a subsequent memory macro. For example, input data DIN are input into the memory macro 802. The memory macro 802 performs one or more CIM operations based on the input data DIN and weight data stored in the memory macro 802, and generates output data DOUT2 as results of the CIM operations. The output data DOUT2 are supplied as input data DIN4 of the memory macro 804. The memory macro 804 performs one or more CIM operations based on the input data DIN4 and weight data stored in the memory macro 804, and generates output data DOUT4 as results of the CIM operations. The output data DOUT4 are supplied as input data DIN6 of the memory macro 806. The memory macro 806 performs one or more CIM operations based on the input data DIN6 and weight data stored in the memory macro 806, and generates output data DOUT6 as results of the CIM operations. The output data DOUT6 are supplied as input data DIN8 of the memory macro 808. The memory macro 808 performs one or more CIM operations based on the input data DIN8 and weight data stored in the memory macro 808, and generates output data DOUT as results of the CIM operations. One or more of the input data DIN, DIN4, DIN6, DIN8 correspond to the input data IN described with respect to FIGS. 3A-7F. In at least one embodiment, the described configuration of the memory macros 802, 804, 806, 808 implements a neural network. In at least one embodiment, one or more advantages described herein are achievable by the memory device 800A.

Reference is now made to FIG. 8B. FIG. 8B is a schematic diagram of a neural network 800B, in accordance with some embodiments.

The neural network 800B includes a plurality of layers A-E each including a plurality of nodes (or neurons). The nodes in successive layers of the neural network 800B are connected with each other by a matrix or array of connections. For example, the nodes in layers A and B are connected with each other by connections in a matrix 812, the nodes in layers B and C are connected with each other by connections in a matrix 814, the nodes in layers C and D are connected with each other by connections in a matrix 816, and the nodes in layers D and E are connected with each other by connections in a matrix 818. Layer A is an input layer configured to receive input data 811. The input data 811 propagate through the neural network 800B, from one layer to the next layer via the corresponding matrix of connections between the layers. As the data propagate through the neural network 800B, the data undergo one or more computations, and are output as output data 819 from layer E which is an output layer of the neural network 800B. Layers B, C, D between input layer A and output layer E are sometimes referred to as hidden or intermediate layers. The number of layers, number of matrices of connections, and number of nodes in each layer in FIG. 8B are examples. Other configurations are within the scopes of various embodiments. For example, in at least one embodiment, the neural network 800B includes no hidden layer, and has an input layer connected by one matrix of connections to an output layer. In one or more embodiments, the neural network 800B has one, two, or more than three hidden layers.

In some embodiments, the matrices 812, 814, 816, 818 are correspondingly implemented by the memory macros 802, 804, 806, 808, the input data 811 correspond to the input data DIN, and the output data 819 correspond to the output data DOUT. Specifically, in the matrix 812, a connection between a node in layer A and another node in layer B has a corresponding weight. For example, a connection between node A1 and node B1 has a weight W (A1,B1) which corresponds to a weight value stored, e.g., in a row or a column of a memory array of the memory macro 802. The memory macros 804, 806, 808 are configured in a similar manner. The weight data in one or more of the memory macros 802, 804, 806, 808 are updated, e.g., by a processor and through the memory controller 820, as machine learning is performed using the neural network 800B. One or more advantages described herein are achievable in the neural network 800B implemented in whole or in part by one or more memory macros and/or memory devices in accordance with some embodiments.

Reference is now made to FIG. 8C. FIG. 8C is a schematic diagram of an integrated circuit (IC) device 800C, in accordance with some embodiments.

The IC device 800C includes one or more hardware processors 832, one or more memory devices 834 coupled to the processors 832 by one or more buses 836. In some embodiments, the IC device 800C includes one or more further circuits including, but not limited to, cellular transceiver, global positioning system (GPS) receiver, network interface circuitry for one or more of Wi-Fi, USB, Bluetooth, or the like. Examples of the processors 832 include, but are not limited to, a central processing unit (CPU), a multi-core CPU, a neural processing unit (NPU), a graphics processing unit (GPU), a digital signal processor (DSP), a field-programmable gate array (FPGA), an application-specific integrated circuit (ASIC), other programmable logic devices, a multimedia processor, an image signal processors (ISP), or the like. Examples of the memory devices 834 include one or more memory devices and/or memory macros described herein. In at least one embodiment, each of the processors 832 is coupled to a corresponding memory device among the memory devices 834.

In some embodiments, the memory devices 834 are CIM memory devices, and various computations are performed in the memory devices which reduces the computing workload of the corresponding processor 832, reduces memory access time, and improves performance. In at least one embodiment, the IC device 800C is a system-on-a-chip (SOC). In at least one embodiment, one or more advantages described herein are achievable by the IC device 800C.

Also disclosed is a memory device. The memory device includes a memory array configured to store weight data; a control logic configured to transmit input data to activate different numbers of multiple word lines in each of multiple cycles of multiply-and-accumulate (MAC) operations on the weight data and the input data; and multiple read circuits coupled to the memory array through multiple bit lines, and configured to generate, in response to a control signal, multiple read voltages based on multiple reference voltages in the cycles of MAC operations to the bit lines. The reference voltages are different from each other.

Also disclosed is a method of operating a memory device. The method includes: performing multiply-and-accumulate (MAC) operations on a first portion of input data and a first portion of weight data in multiple first cycles, including: applying a first read voltage to multiple bit lines coupled to multiple memory cells storing the weight data; and activating a first number of word lines in each of the first cycles; and performing MAC operations on the first portion of the input data and a second portion of the weight data in multiple second cycles, including: applying a second read voltage to the bit lines, wherein the first read voltage and the second read voltage are different from each other; and activating a second number of the word lines in each of the second cycles.

Also disclosed is a memory device. The memory device includes a memory array coupled to multiple word lines and including multiple memory cells; and a read circuit coupled to the memory array, and configured to generate, in response to a control signal, a read voltage based on selected reference voltage in multiple reference voltages. A first number of cells in the memory cells arranged in a first column are configured to generate a first read current in response to the read voltage and multiple first word lines in the word lines being activated. A second word lines in the word lines are configured to be deactivated, the second word lines being coupled to a second number of cells in the memory cells arranged in the first column.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A memory device, comprising:
a memory array configured to store weight data;
a control logic configured to transmit input data to activate different numbers of a plurality of word lines in each of a plurality of cycles of multiply-and-accumulate (MAC) operations on the weight data and the input data; and
a plurality of read circuits coupled to the memory array through a plurality of bit lines, and configured to generate, in response to a control signal, a plurality of read voltages based on a plurality of reference voltages in the plurality of cycles of MAC operations to the plurality of bit lines,
wherein the plurality of reference voltages are different from each other.

2. The memory device of claim 1, wherein a first number of word lines in the plurality of word lines are activated in each of first cycles of the plurality of cycles, and a second number of word lines in the plurality of word lines are activated in each of second cycles of the plurality of cycles,
wherein the first number is smaller than the second number, and a number of the first cycles is greater than a number of the second cycles.

3. The memory device of claim 1, wherein the control logic activates a first number of word lines in the plurality of word lines in each of first cycles of the plurality of cycles, and
the plurality of read circuits generate a first read voltage in the plurality of read voltages based on a first reference voltage in the plurality of reference voltages.

4. The memory device of claim 3, wherein the control logic activates a second number of word lines in the plurality of word lines in each of second cycles of the plurality of cycles, and
the plurality of read circuits generate a second read voltage in the plurality of read voltages based on a second reference voltage in the plurality of reference voltages,
wherein the first number is smaller than the second number, and the first read voltage is greater than the second read voltage.

5. The memory device of claim 4, wherein the memory array comprises a plurality of memory cells, and first and second cells in the memory cells have a resistance,
wherein the first cell is coupled to the first number of word lines to generate a first current, and the second cell is coupled to the second number of word lines to generate a second current,
wherein the first current is greater than the second current.

6. The memory device of claim 1, wherein each of the plurality of read circuits comprises:
a plurality of switches having first terminals coupled to the plurality of reference voltages;
an amplifier having a first input coupled to second terminals of the plurality of switches; and
a transistor coupled between a supply voltage terminal and the memory array, and comprising a gate terminal coupled to an output terminal of the amplifier and a source/drain terminal coupled to the memory array and an second input of the amplifier.

7. The memory device of claim 6, wherein the plurality of switches are configured to be switched in response to the control signal.

8. A method, comprising:
performing multiply-and-accumulate (MAC) operations on a first portion of input data and a first portion of weight data in a plurality of first cycles, comprising:
applying a first read voltage to a plurality of bit lines coupled to a plurality of memory cells storing the weight data; and
activating a first number of word lines in each of the plurality of first cycles; and
performing MAC operations on the first portion of the input data and a second portion of the weight data in a plurality of second cycles, comprising:
applying a second read voltage to the plurality of bit lines, wherein the first read voltage and the second read voltage are different from each other; and
activating a second number of the word lines in each of the plurality of second cycles.

9. The method of claim 8, wherein a number of the plurality of first cycles is greater than a number of the plurality of second cycles.

10. The method of claim 8, wherein the first number of the word lines is smaller than the second number of the word lines.

11. The method of claim 8, wherein the first portion of the weight data comprises most significant bits of the weight data, and the second portion of the weight data comprises least significant bits of the weight data.

12. The method of claim 8, wherein the first read voltage is greater than the second read voltage.

13. The method of claim 8, wherein performing the MAC operations on the first portion of the input data and the second portion of the weight data further comprises:
generating the first read voltage based on a first reference voltage and a voltage of one bit line in the plurality of bit lines.

14. The method of claim 13, wherein performing the MAC operations on the first portion of the input data and the first portion of the weight data further comprises:
generating the second read voltage based on a second reference voltage and the voltage of one bit line in the plurality of bit lines,
wherein the second reference voltage is greater than the first reference voltage.

15. The method of claim 8, further comprising:
performing MAC operations on a second portion of the input data and the first portion of the weight data in a plurality of third cycles, comprising:
applying a third read voltage to the plurality of bit lines; and
activating a third number of the word lines in each of the plurality of third cycles; and
performing MAC operations on the second portion of the input data and the second portion of the weight data in a plurality of fourth cycles, comprising:
applying a fourth read voltage to the plurality of bit lines; and
activating a fourth number of the word lines in each of the plurality of fourth cycles.

16. The method of claim 15, wherein the fourth read voltage is smaller than the first read voltage, the second read voltage, and the third read voltage.

17. A memory device, comprising:
a memory array coupled to a plurality of word lines and comprising a plurality of memory cells; and
a read circuit coupled to the memory array, and configured to generate, in response to a control signal, a read voltage based on selected reference voltage in a plurality of reference voltages,
wherein a first number of cells in the plurality of memory cells arranged in a first column are configured to generate a first read current in response to the read voltage and a plurality of first word lines in the plurality of word lines being activated,
wherein a plurality of second word lines in the plurality of word lines are configured to be deactivated, the plurality of second word lines being coupled to a second number of cells in the plurality of memory cells arranged in the first column.

18. The memory device of claim 17, wherein the read circuit comprises:
a plurality of switches having first terminals coupled to the plurality of reference voltages;
an amplifier having a first input coupled to second terminals of the plurality of switches; and
a transistor coupled between a supply voltage terminal and the memory array, and comprising a gate terminal coupled to an output terminal of the amplifier and a source/drain terminal coupled to the memory array and an second input of the amplifier.

19. The memory device of claim 17, wherein the read circuit generates, based on a first reference voltage in the plurality of reference voltages, the read voltage to have a first voltage level when the first number of word lines are activated,
wherein the read circuit generates, based on a second reference voltage in the plurality of reference voltages, the read voltage to have a second voltage level when the a plurality of third word lines in the plurality of word lines are activated,
wherein a number of the plurality of first word lines is smaller than a number of plurality of third word lines, and the first voltage level is greater than the second voltage level.

20. The memory device of claim 17, wherein the plurality of memory cells are arranged in a plurality of rows and configured to store weight data,
wherein cells in the plurality of memory cells are arranged in a first row and configured to store least significant bits in the weight data, and cells in the plurality of memory cells are arranged in a second row and configured to store most significant bits in the weight data.
